(19) United States
(12) Patent Application Publication
(10) Pub. No.: US 2007/0169068 A1
(43) Pub. Date: Jul. 19, 2007

(54) Function calling method for computer system, computer system, and library

(75) Inventors: Koji Kanazawa, Ome-shi (JP); Kazuo Kawabe, Nishitama-gun (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/603,298

(22) Filed: Nov. 20, 2006

(30) Foreign Application Priority Data
Dec. 15, 2005 (JP) 2005-361956

(51) Int. Cl. G06F 9/44

(52) U.S. Cl. 717/163

(57) ABSTRACT

According to one embodiment, a computer system includes a library which supplys a plurality of functions, and a program which calls the function, and the program including a function calling unit which disguises, upon calling a first function from the library, the calling process of the first function as a calling process of a second function, and a return value obtaining unit which obtains a return value of the second function from the library as a return value of the first function, and the library including, a function call reception unit which converts, receiving a request to call the second function from the program, the calling process of the second function into the calling process of the first function, and a return value send back unit which sends back, to the program, the return value of the first function as the return value of the second function.

### CROSS-REFERENCE TO RELATED APPLICATIONS

This application is based upon and claims the benefit of priority from Japanese Patent Application No. 2005-361956, filed Dec. 15, 2005, the entire contents of which are incorporated herein by reference.

### BACKGROUND

1. Field

One embodiment of the invention relates to a function call control technique of modularizing a function inhibited from leaking to a third party, while maintaining confidentiality. For example, the function to be modularized includes a process of decrypting encrypted data.

2. Description of the Related Art

As compression coding techniques and image processing techniques have improved in recent years, movies and music videos can generally be enjoyed by using software running on a personal computer. Recently, a personal computer with a TV function of receiving and playing back a television broadcast signal has also become popular. When carrying a battery powered notebook type personal computer with such a TV function, a user can enjoy a TV program even while the user is out or on the move.

A digital TV broadcast program broadcast from a digital TV broadcast station is encrypted to inhibit an unauthorized user from viewing it. In order to install a TV function for receiving and playing back such a digital TV broadcast program, a processing procedure of decrypting encrypted digital TV broadcast program data needs to be incorporated in software.

In incorporating a new function in software, a processing procedure of implementing the new function is not held in each software program, but is generally modularized to be used from a plurality of software programs. That is, the processing procedure is modularized as one function in a library.

When the processing procedure of decrypting the encrypted digital TV broadcast program data is modularized as one function in the library, the processing procedure can be used from any program in principle. However, depending on the characteristics of the procedure such as the decryption process, many processing procedures can be called from only an authorized program as exceptional cases so as to protect confidentiality and the like. Hence, various proposals have been made to call a function in the library from only a specific program (for example, see Jpn. Pat. Appln. KOKAI Publication No. 2002 99439).

By a conventional technique such as Jpn. Pat. Appln. KOKAI Publication No. 2002 99439, a function can be set to be called from only a specific program (authenticated program). However, a parameter and return value can be transmitted and received between the authorized program and the function in the same manner as between a general program and the function. That is, the presence of the function cannot be concealed. Therefore, upon wire tapping and analyzing the communication between the authorized program and the function, the processing procedure of this function may leak to a third party. To prevent this, actually, a function inhibited from leaking to a third party cannot be modularized, and cannot but be held in each software program.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the schematic arrangement of a computer system according to an embodiment of the present invention;

FIG. 2 is an exemplary block diagram for explaining a mechanism for calling a function in the computer system according to the embodiment;

FIG. 3 is an exemplary functional block diagram of an application program running on the computer system, and a dynamic library for supplying a function to the application program according to the embodiment; and

FIG. 4 is an exemplary timing chart showing an operation procedure between the application program running on the computer system, and the dynamic library for supplying a function to the application program according to the embodiment.

### DETAILED DESCRIPTION

Various embodiments according to the invention will be described hereinafter with reference to the accompanying drawings. In general, according to one embodiment of the invention, a computer system includes a library which supplys a plurality of functions, and a program which calls the function, and the program including a function calling unit which disguises, upon calling a first function from the library, the calling process of the first function as a calling process of a second function, and a return value obtaining unit which obtains a return value of the second function from the library as a return value of the first function, and the library including, a function call reception unit which converts, receiving a request to call the second function from the program, the calling process of the second function into the calling process of the first function, and a return value send back unit which sends back, to the program, the return value of the first function as the return value of the second function.

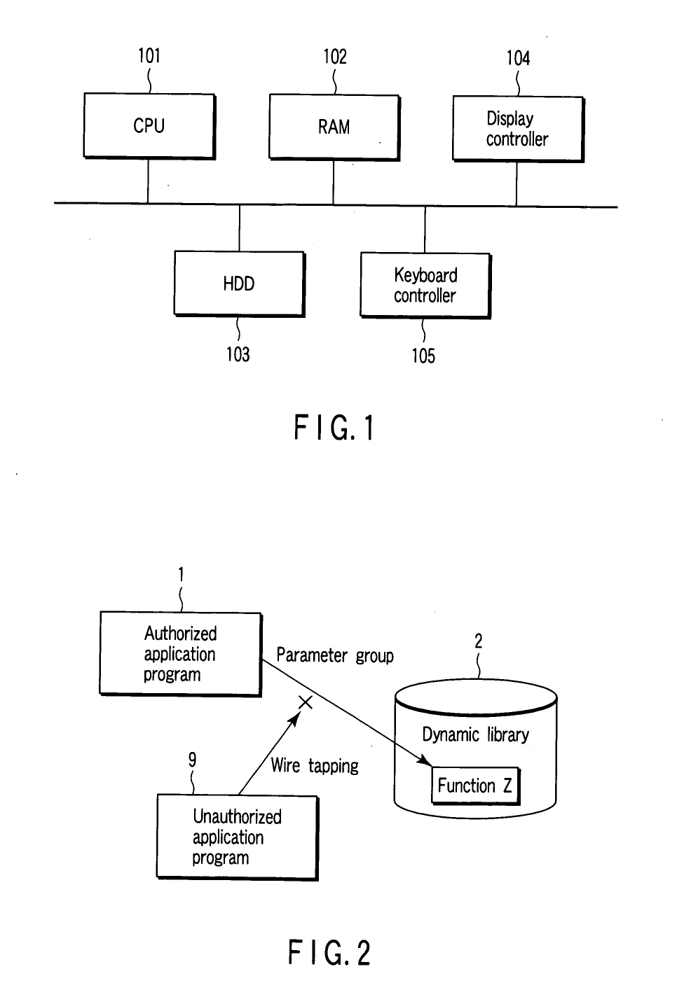

FIG. 1 shows the exemplary schematic arrangement of a computer system according to an embodiment of the present invention. For example, the computer system according to this embodiment is a notebook or desktop type personal computer to be used by a general user. As shown in FIG. 1, this computer system has a CPU 101, RAM 102, hard disk drive (HDD) 103, display controller 104, and keyboard controller 105.

The CPU 101 controls the overall computer system, and executes various programs such as an operating system, utility program, and application program loaded from the HDD 103 into the RAM 102.

The RAM 102 is a memory device serving as a main memory of this computer system and stores various programs and various data as the work area of the CPU 101. The HDD 103 is a storage device serving as the external storage of this computer system and stores various programs and various data in large quantities as an auxiliary device of the RAM 102.

The display controller 104 is a device which controls output of a user interface of this computer system, and displays and controls, on a display, various images generated by the programs executed by the CPU 101. On the other hand, the keyboard controller 105 is a device which controls input of the user interface of this computer system, converts operations of a keyboard into digital data, and supplies the digital data to the program executed by the CPU 101.

This computer system with such a hardware configuration includes a library for supplying a plurality of functions to be used by various application programs. The function in the library may be modularized as a sub module, and can be called from any program in principle. However, an exceptional function is also present. This exceptional function is set to be called from only a specific program, and its presence needs to be concealed from other programs other than the specific program, although the function needs to be modularized. To achieve this, as shown in FIG. 2, this computer system has a mechanism for inhibiting an unauthorized application program 9 from wire tapping transmission/reception of a parameter and return value of a function Z or the like between an authorized application program 1 and a dynamic library 2. This mechanism will be described below.

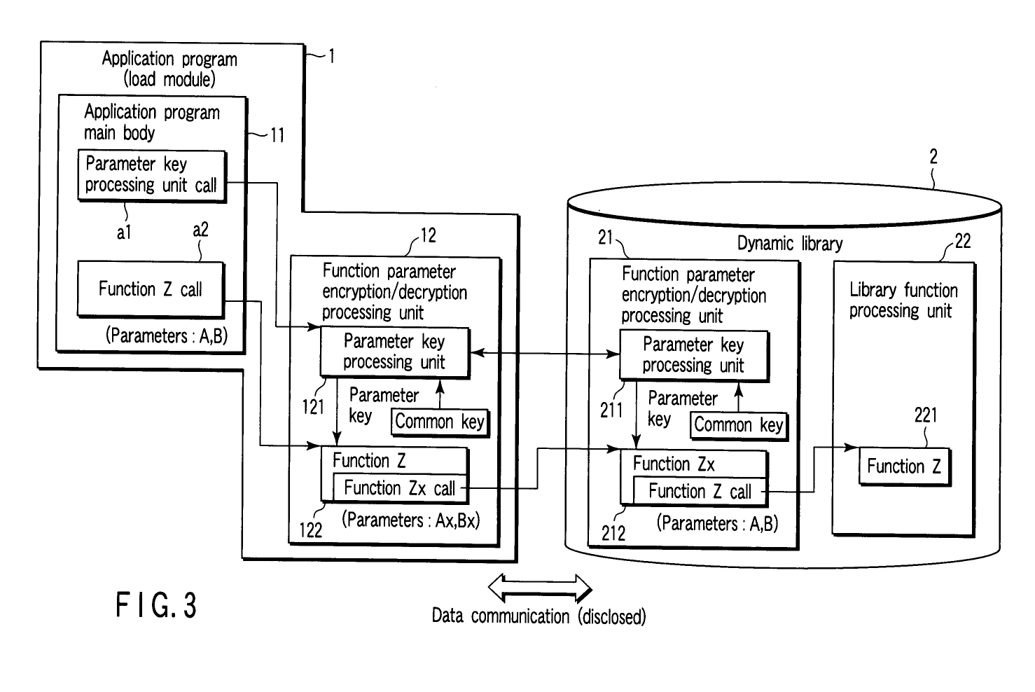

FIG. 3 is an exemplary functional block diagram of the application program 1 running on the computer system, and the dynamic library 2 which supplies the function Z to the application program 1. Assume that the function Z is a modularized function such as a processing procedure of decrypting encrypted digital TV broadcast program data inhibited from leaking to a third party, and has two parameters A and B.

Referring to FIG. 3, the application program 1 includes an application program main body 11 and function parameter encryption/decryption processing unit 12. The function parameter encryption/decryption processing unit 12 includes a parameter key processing unit 121 and a function Z 122 for disguising the calling process of a function Z 221 as something else. On the other hand, the dynamic library 2 includes a function parameter encryption/decryption processing unit 21 and library function processing unit 22. The function parameter encryption/decryption processing unit 21 includes a parameter key processing unit 211, and a function Zx 212 which is called after disguise processing and mediates the calling process of the function Z 221.

Each of the function parameter encryption/decryption processing unit 12 in the application program 1 and the function parameter encryption/decryption processing unit 21 in the dynamic library 2 has a common key with the same value in advance. The function parameter encryption/decryption processing units 12 and 21 are respectively arranged in the application program 1 and dynamic library 2 to disguise the calling process of the function Z 221 from the application program main body 11 (into the calling process of the function Zx) as another event. That is, the application program main body 11 and function Z 221 do not concern this disguise process.

Prior to a calling process (a2) of the function Z, the application program main body 11 executes a calling process (a1) of the parameter key processing unit 121. Upon reception of the call, the parameter key processing unit 121 in the function parameter encryption/decryption processing unit 12 requests the parameter key processing unit 211 on the dynamic library 2 side to generate a parameter key. On the other hand, the parameter key processing unit 211 which has received this request encrypts an arbitrarily generated parameter key with the common key. The parameter key processing unit 211 then sends back the encrypted parameter key to the parameter key processing unit 121 on the application program 1 side, and passes the generated parameter key to the function Zx 212. The parameter key processing unit 121 decrypts, with the common key, the parameter key sent back from the parameter key processing unit 211 on the dynamic library 2 side, and then passes the decrypted parameter key to the function Z 122.

Upon completion of the calling process (a1) of the parameter key processing unit 121, the application program main body 11 executes the calling process (a2) of the function Z to actually call the function Z 122 in the function parameter encryption/decryption processing unit 12. At this time, the parameters A and B to be originally transmitted to the dynamic library 2 are passed to the function Z 122 in the function parameter encryption/decryption processing unit 12.

Upon reception of the call, the function Z 122 encrypts the parameters A and B passed in this calling process, with the parameter key from the parameter key processing unit 121. The function Z 122 calls the function Zx 212 of the dynamic library 2 by using encrypted parameters (parameters Ax and Bx). Hence, the function Z 221 is not called, and the parameter is not exchanged between the application program 1 and the dynamic library 2.

Upon reception of the call, the function Zx 212 decrypts the parameters Ax and Bx passed in this calling process, with the parameter key from the parameter key processing unit 211 to obtain the original parameters A and B. The function Zx 212 calls the function Z 221 in the same dynamic library 2 by using the obtained parameters A and B. With this processing, this computer system can call the function Z 221 while concealing its presence. Accordingly, the function inhibited from leaking to a third party can be modularized as the function Z 221.

The result obtained by processing the function Z 221, i.e., the return value is sent back to the function Zx 212 serving as a call source. The function Zx 212 encrypts the received return value with the parameter key from the parameter key processing unit 211. The function Zx 212 then sends back the encrypted return value to the function Z 122 serving as its call source. The function Z 122 decrypts the received return value with the parameter key from the parameter key processing unit 121, and then sends back the decrypted return value to the application program main body 11 serving as its call source.

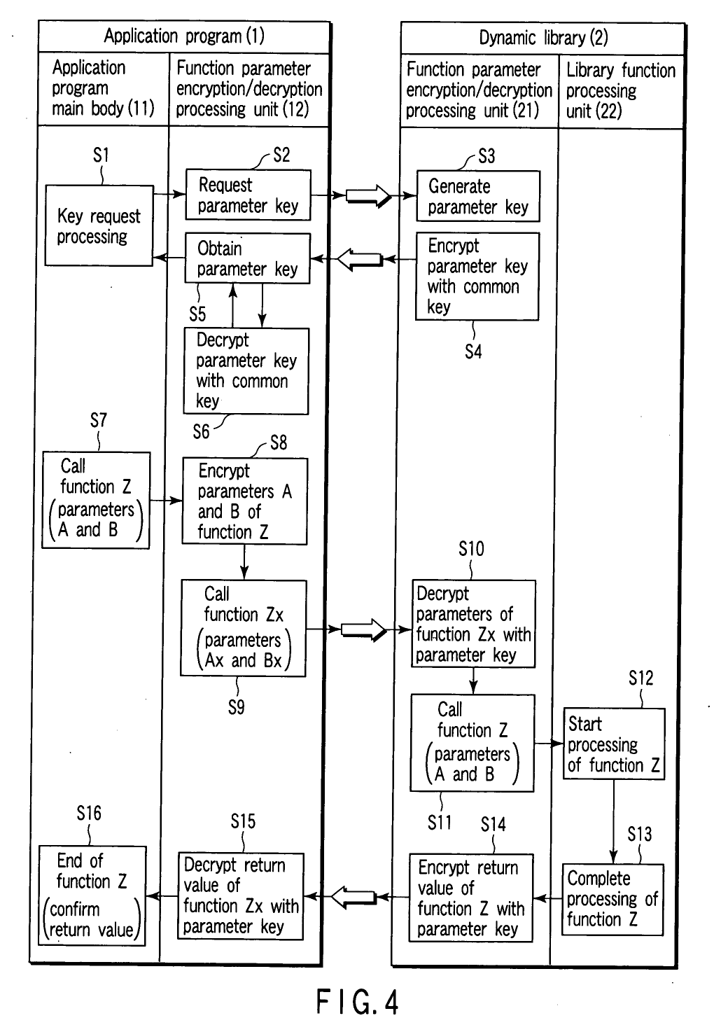

FIG. 4 is an exemplary timing chart showing an operation procedure between the application program 1 running on this computer system, and the dynamic library 2 for supplying the function Z to the application program 1.

First, the application program main body 11 executes a key request process of calling the parameter key processing unit 121 in the function parameter encryption/decryption processing unit 12 (S1). The function parameter encryption/decryption processing unit 12 calls the parameter key processing unit 211 in the function parameter encryption/decryption processing unit 21 on the dynamic library 2 side (S2). Upon reception of the call, the function parameter encryption/decryption processing unit 21 generates a parameter key (S3), encrypts the generated parameter key with the common key, and sends back the encrypted parameter key (S4). On the other hand, when obtaining this parameter key (S5), the function parameter encryption/decryption processing unit 12 recognizes that the obtained parameter key is encrypted, and decrypts it with the common key (S6).

After that, when the application program main body 11 tries to call the function Z 221 from the dynamic library 2 (S7), the function Z 122 in the function parameter encryption/decryption processing unit 12 is called to pass the parameters A and B to the function Z 122. The function Z 122 encrypts the parameters A and B with the parameter key generated by the function parameter encryption/decryption processing unit 21 in the dynamic library 2 (S8) to call the function Zx in the dynamic library 2 by using the encrypted parameters Ax and Bx (S9).

On the other hand, upon reception of the call of the function Zx 212, the function parameter encryption/decryption processing unit 21 in the dynamic library 2 decrypts the parameters Ax and Bx with the parameter key (S10) to call the function Z by using the decrypted original parameters A and B (S11). The library function processing unit 22 processes the function Z 221 by using the parameters A and B (S12), and then sends back the return value to the function Zx 212 after completion of processing of the function Z 221 (S13).

Upon receiving the return value from the function Z 221, the function Zx 212 encrypts the return value with the parameter key at this time, and then sends back the encrypted return value to the function parameter encryption/decryption processing unit 12 in the application program 1 serving as the call source (S14). On the other hand, the function parameter encryption/decryption processing unit 12 decrypts this return value with the parameter key, and sends back the decrypted return value to the application program main body 11 (S15). The application program main body 11 receives this return value to end processing for the function Z 221. After that, processing shifts to a subsequent process (S16).

As described above, this computer system can modularize a function such as a processing procedure of decrypting an encrypted digital TV broadcast program inhibited from leaking to a third party, while maintaining confidentiality. Hence, the present invention can reduce the number of opcodes and improve the efficiency of software development in comparison with a case wherein the function is held in each software program conventionally.

The function parameter encryption/decryption processing units 12 and 21 can be reused by preparing a versatile interface to be incorporated in a program.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A function calling method for a computer system in which a library for supplying a plurality of functions transmits/receives a parameter and a return value to/from a program for calling the function, comprising:
holding, in advance, an identical common key for encrypting data in both the library and the program;
outputting, from the program to the library, a request to generate a parameter key for encrypting the parameter and the return value;
generating the parameter key in the library in response to the request from the program, encrypting the generated parameter key with the common key, and transmitting the encrypted parameter key to the program;
decrypting, in the program, the parameter key from the library with the common key, encrypting, with the parameter key, the parameter for a calling process of a first function, and requesting the library to call a second function set to disguise the calling process of the first function by using the encrypted parameter as another event;
decrypting, in the library, the parameter used to call the second function with the parameter key, calling the first function by using the decrypted parameter, encrypting a return value of the first function with the parameter key, and sending back the encrypted return value as the return value of the second function; and
decrypting, in the program, the return value of the second function from the library with the parameter key, and setting the decrypted return value as the return value of the first function.

2. A computer system comprising:
a library configured to supply a plurality of functions; and
a program configured to call the function, and
the program including:
a function calling unit configured to, upon calling a first function from the library, disguise the calling process of the first function as a calling process of a second function; and
a return value obtaining unit configured to obtain a return value of the second function from the library as a return value of the first function, and
the library including:
a function call reception unit configured to, receiving a request to call the second function from the program, convert the calling process of the second function into the calling process of the first function; and
a return value send back unit configured to send back, to the program, the return value of the first function as the return value of the second function.

3. The computer system according to claim 2, wherein in the program,
the function calling unit encrypts a parameter for a calling process of the first function with a parameter key, and calls the second function by using the encrypted parameter, and
the return value obtaining unit decrypts the return value of the second function from the library with the parameter key, and
in the library,
the function call reception unit decrypts the parameter used to call the second function, with the parameter key, and
the return value send back unit encrypts the return value of the first function with the parameter key.

4. The computer system according to claim 3, wherein both the library and the program hold an identical common key for encrypting data,
the program further including parameter key obtaining unit configured to request the library to generate the parameter key, and to decrypt the parameter key from the library with the common key, and
the library further including parameter key generation unit configured to generate the parameter key in response to the request from the program, to encrypt the generated parameter key with the common key, and to transmit the encrypted parameter key to the program.

5. A library which is arranged in a computer system, and supplies a plurality of functions to a program running on the computer system, comprising:
a function call reception unit configured to, upon receiving a request to call a second function set to disguise a calling process of a first function as another event from the program, convert the calling process of the second function into the calling process of the first function; and
a return value send back unit configured to send back, to the program, a return value of the first function as a return value of the second function.

6. A library according to claim 5, wherein
the function call reception unit decrypts, with a parameter key, a parameter used to call the second function, and
the return value send back unit encrypts the return value of the first function with the parameter key.

7. The library according to claim 6, further comprising parameter key generation unit configured to generate the parameter key in response to the request from the program, to encrypt the generated parameter key with a prepared common key, and to transmit the encrypted parameter key to the program.
